(19) United States
(12) Patent Application Publication
(10) Pub. No.: US 2020/0099828 A1
(43) Pub. Date: Mar. 26, 2020

(54) MONITORING DEVICE CONFIGURED TO ATTACH TO AN OVERHEAD STRAND HOLDING A COMMUNICATION CABLE AND METHOD OF INSTALLING AND USING SAME

(71) Applicant: SecureWatch24, LLC, New York, NY (US)

(72) Inventors: Eugene W. Dell'Aglio, New York, NY (US); Desmond N. Smyth, New York, NY (US); John J. Colgan, New York, NY (US); Neil K. Wiener, New York, NY (US)

(21) Appl. No.: 16/698,326

(22) Filed: Nov. 27, 2019

Related U.S. Application Data
(63) Continuation of application No. PCT/US2018/036226, filed on Jun. 6, 2018.
(60) Provisional application No. 62/516,421, filed on Jun. 7, 2017.

(51) Int. Cl. H04N 5/225; H02G 1/02; H02G 7/05; G03B 17/02; G03B 17/56; H04N 7/18; H04N 5/232

(52) U.S. Cl. CPC H04N 5/2252; H02G 1/02; H02G 7/05; H04N 5/23206; G03B 17/561; H04N 5/2253; H04N 7/181; G03B 17/02

(57) ABSTRACT

Apparatuses and methods for hanging a plurality of sensors from an overhead strand holding one or more communication cables are described herein. In an example embodiment, a monitoring device includes a first housing portion including a bottom surface and a plurality of side surfaces, wherein at least one of the bottom surface and the plurality of side surfaces includes at least one aperture configured to receive a sensor, a second housing portion configured to attach to the first housing portion, thereby providing an inner space between the first and second housing portions, an attachment device enabling the attached first and second housing portions to hang from an overhead strand, and a connector configured to receive power from a communication line tap to power at least one component within the inner space while the attachment device hangs the housing from the overhead strand.

### CROSS-REFERENCE TO RELATED APPLICATIONS

This application is a continuation of International Application No. PCT/US2018/036226, filed Jun. 6, 2018, which claims the benefit of U.S. Provisional Application No. 62/516,421, filed on Jun. 7, 2017, entitled “MONITORING DEVICE CONFIGURED TO ATTACH TO AN OVERHEAD STRAND HOLDING A COMMUNICATION CABLE AND METHOD OF INSTALLING AND USING SAME,” the entire contents of which are incorporated herein by reference and relied upon.

### FIELD OF THE INVENTION

The present disclosure relates generally to apparatuses and methods for hanging a plurality of sensors from an overhead strand holding one or more communication cables, and more specifically to apparatuses and methods for hanging a plurality of cameras in a way that maximizes the area monitored by the cameras.

### BACKGROUND

Monitoring devices provide convenient methods for obtaining a wide variety of information, enabling a user to manage, direct and/or protect others for any number of reasons. Current monitoring devices, however, are limited in where they can be positioned and in the area that they can cover. The limitations can be for a variety of reasons, for example, electrical needs, permits required to access certain spaces, and field of view restrictions.

### SUMMARY

The present disclosure solves the above limitations by providing a monitoring device configured to hang from an overhead strand holding one or more communication cables and to provide a wide field of view by positioning a plurality of sensors at a plurality of positions. In a general embodiment, which may be combined with any other embodiment disclosed herein, a monitoring device includes a first housing portion including a bottom surface and a plurality of side surfaces positioned to form an open top side, wherein at least one of the plurality of side surfaces is angled outwardly from the bottom surface towards the open top side, and wherein at least one of the bottom surface and the plurality of side surfaces includes at least one aperture configured to receive a sensor, a second housing portion configured to attach to the first housing portion so as to cover the open top side of the first housing portion, thereby providing an inner space between the first and second housing portions, an attachment device enabling the attached first and second housing portions to hang from an overhead strand, and a connector configured to receive power from a communication line tap to power at least one component within the inner space while the attachment device hangs the first and second housing portions from the overhead strand.

In another embodiment, which may be combined with any other embodiment disclosed herein, two opposing surfaces of the plurality of side surfaces include at least two apertures each configured to receive a sensor.

In another embodiment, which may be combined with any other embodiment disclosed herein, each aperture is positioned such that a sensor can protrude from the inner space therethrough.

In another embodiment, which may be combined with any other embodiment disclosed herein, the second housing portion includes a curved upper surface.

In another embodiment, which may be combined with any other embodiment disclosed herein, at least one of the plurality of side surfaces has a trapezoid shape.

In another embodiment, which may be combined with any other embodiment disclosed herein, the first housing portion includes four side surfaces, and all four side surfaces have trapezoid shapes.

In another embodiment, which may be combined with any other embodiment disclosed herein, the plurality of side surfaces includes a first set of opposed side surfaces and a second set of opposed side surfaces, and wherein the first set of opposed side surfaces is at least twice as long as the second set of opposed side surfaces when measured from a bottom edge.

In another embodiment, which may be combined with any other embodiment disclosed herein, the plurality of side surfaces includes a first set of opposed side surfaces and a second set of opposed side surfaces, and the first set of opposed side surfaces is at least three times as long as the second set of opposed side surfaces when measured from a bottom edge.

In another embodiment, which may be combined with any other embodiment disclosed herein, a top edge of at least one of the side surfaces is at least twice as long as a height of the at least one of the side surfaces.

In another embodiment, which may be combined with any other embodiment disclosed herein, the second housing portion is removably attachable to the first housing portion.

In another embodiment, which may be combined with any other embodiment disclosed herein, each aperture is configured to interchangeably receive a plurality of different types of sensors.

In another embodiment, which may be combined with any other embodiment disclosed herein, the at least one component within the inner space includes at least one of a sensor control unit, a POE unit and a modem.

In another embodiment, which may be combined with any other embodiment disclosed herein, the at least one of the sensor control unit, the POE unit and the modem is attached to a surface of the second housing portion.

In another embodiment, which may be combined with any other embodiment disclosed herein, the attachment device is attached to the second housing portion.

In another embodiment, which may be combined with any other embodiment disclosed herein, the bottom surface and at least one of the plurality of side surfaces each include at least one aperture configured to receive a sensor.

In another general embodiment, which may be combined with any other embodiment disclosed herein, a monitoring device includes a housing having an inner space enclosed by a bottom surface, at least one side surface, and a top surface, the at least one side surface angled outwardly from the bottom surface to the top surface, at least one sensor positioned at an aperture in at least one of the bottom surface and the at least one side surface, an attachment device enabling the housing to hang from an overhead strand, and a connector configured to transfer power from a communication line tap to power the at least one sensor while the attachment device hangs the housing from the overhead strand.

In another embodiment, which may be combined with any other embodiment disclosed herein, the monitoring device includes a plurality of sensors positioned at a plurality of apertures in at least one of the bottom surface and the at least one side surface, and the plurality of sensors are each connected to a sensor control unit located within the inner space.

In another embodiment, which may be combined with any other embodiment disclosed herein, the connector is an F connector configured to couple to a communication line connected to the communication line tap.

In another embodiment, which may be combined with any other embodiment disclosed herein, the housing includes a first housing portion and a second housing portion, the first housing portion providing the bottom surface and the at least one side surface, the second housing portion providing the top surface.

In another embodiment, which may be combined with any other embodiment disclosed herein, the second housing portion is removeably attachable to the first housing portion.

In another embodiment, which may be combined with any other embodiment disclosed herein, the bottom surface is an edge where two side surfaces meet.

In another embodiment, which may be combined with any other embodiment disclosed herein, the connector is configured to transfer power to a POE unit, and the POE unit provides power to the at least one sensor.

In another embodiment, which may be combined with any other embodiment disclosed herein, the POE unit provides power to a modem.

In another general embodiment, which may be combined with any other embodiment disclosed herein, a method of installing a monitoring device includes configuring a monitoring device with at least one sensor, hanging the monitoring device from an overhead strand attached to a utility pole, and connecting a communication line from a communication line tap to the monitoring device to power the at least one sensor.

In another embodiment, which may be combined with any other embodiment disclosed herein, the method includes wirelessly controlling the at least one sensor.

In another embodiment, which may be combined with any other embodiment disclosed herein, the method includes wirelessly retrieving data from the at least one sensor.

In another embodiment, which may be combined with any other embodiment disclosed herein, the method includes configuring the monitoring device with a plurality of different types of sensors.

### BRIEF DESCRIPTION OF THE FIGURES

Embodiments of the present disclosure will now be explained in further detail by way of example only with reference to the accompanying figures, in which:

FIG. 1 is a perspective view of an example embodiment of a monitoring device in accordance with the present disclosure;

FIG. 2 is a perspective view of the monitoring device of FIG. 1 with separated first and second housing portions;

FIG. 3 is a front plan view of the monitoring device of FIG. 1;

FIG. 4 is a side plan view of the monitoring device of FIG. 1;

FIG. 5 is a top elevational view of the monitoring device of FIG. 1;

FIG. 6 is a bottom perspective view of the first housing portion of the monitoring device of FIG. 1;

FIG. 7 is a bottom elevational view of the first housing portion of the monitoring device of FIG. 1;

FIG. 8 is a bottom perspective view of the second housing portion of the monitoring device of FIG. 1;

FIG. 9 is a cross sectional view taken across line IX-IX in FIG. 4;

FIG. 10 is a cross-sectional view taken across line X-X in FIG. 3;

FIG. 11 is a wiring diagram showing an example embodiment of the electronic components of monitoring device 10;

FIG. 12 illustrates an example embodiment of the monitoring device of FIG. 1 hanging from an overhead strand; and

FIG. 13 is a perspective view of an example embodiment of a monitoring device in accordance with the present disclosure;

FIG. 14 is a front plan view of the monitoring device of FIG. 13;

FIG. 15 is a side plan view of the monitoring device of FIG. 13;

FIG. 16 is a bottom elevational view of the monitoring device of FIG. 13;

FIG. 17 is a perspective view of the monitoring device of FIG. 13 with separated first and second housing portions;

FIG. 18 is a perspective view of an example embodiment of a monitoring device in accordance with the present disclosure;

FIG. 19 is a front plan view of the monitoring device of FIG. 18;

FIG. 20 is a side plan view of the monitoring device of FIG. 18;

FIG. 21 is a perspective view of the monitoring device of FIG. 18 with separated first and second housing portions;

FIG. 22 is a perspective view of the second housing portion of the monitoring device of FIG. 18;

FIG. 23 is a perspective view of the second housing portion of the monitoring device of FIG. 18;

FIG. 24 is a perspective view of an example embodiment of a stabilizing device that may stabilize a monitoring device attached to an overhead strand;

FIG. 25 is a perspective view of the stabilizing device of FIG. 24;

FIG. 26 is a perspective view of the stabilizing device of FIG. 24;

FIG. 27 is a perspective view of the stabilizing device of FIG. 24;

FIG. 28 illustrates a method of installing the monitoring devices disclosed herein.

### DETAILED DESCRIPTION

Before the disclosure is described, it is to be understood that this disclosure is not limited to the particular apparatuses and methods described. It is also to be understood that the terminology used herein is for the purpose of describing particular embodiments only, and is not intended to be limiting, since the scope of the present disclosure will be limited only to the appended claims.

As used in this disclosure and the appended claims, the singular forms “a,” “an” and “the” include plural referents unless the context clearly dictates otherwise. The methods and apparatuses disclosed herein may lack any element that is not specifically disclosed herein.

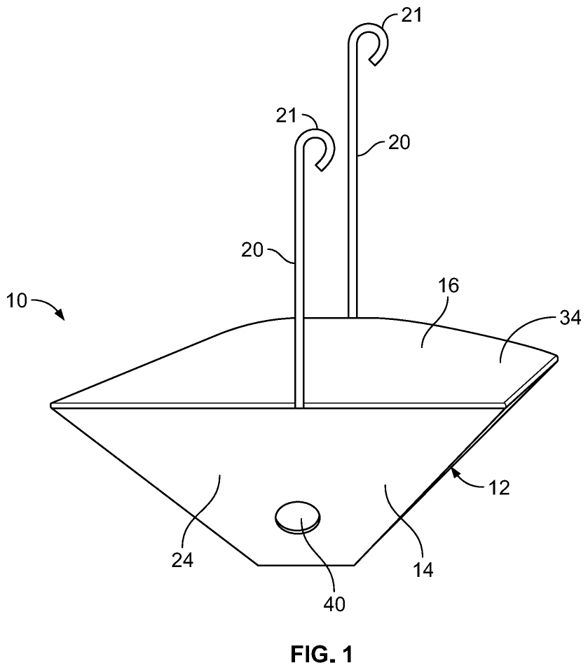

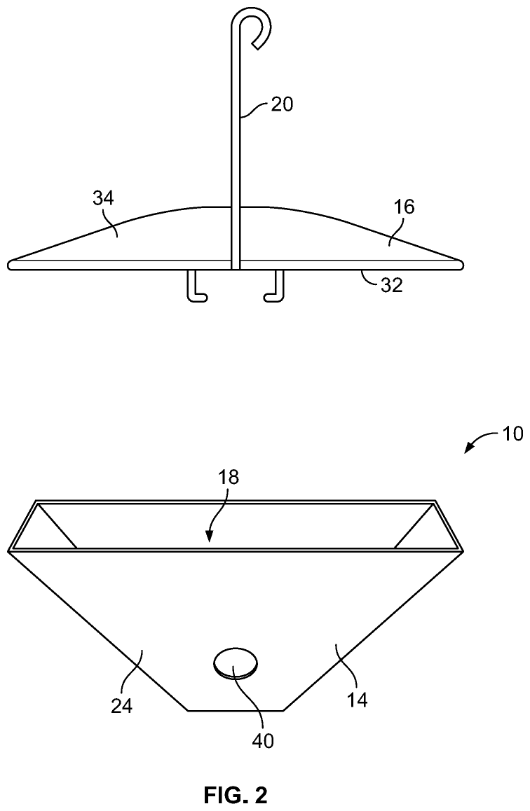

FIGS. 1 and 2 illustrate an example embodiment of a monitoring device 10 according to the present disclosure. As illustrated, monitoring device 10 includes a housing 12 having a first or lower housing portion 14 and a second or upper housing portion 16. FIG. 1 shows first housing portion 14 and second housing portion 16 removeably attached to enclose an inner space 18, while FIG. 2 shows second housing portion 16 detached from first housing portion 14 to reveal inner space 18 so that inner space 18 may be accessed by a user. In use, and as explained in more detail below, monitoring device 10 includes an attachment device 20 enabling housing 12 to hang from an overhead strand positioned approximately horizontally across one or more utility poles. The overhead strand is typically, for example, a galvanized steel cable from which communication cables are hung and which is located beneath the power lines on the utility pole.

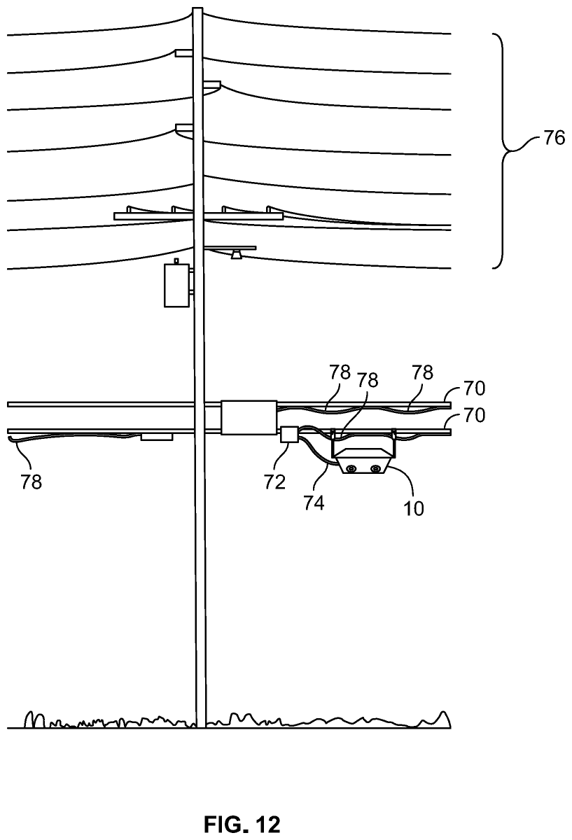

Attachment device 20 enables housing 12 to hang from an overhead strand, as illustrated for example in FIG. 12. In the illustrated embodiment, attachment device 20 includes a contact portion 21 that is configured to contact and thereby attach to the overhead strand. In the illustrated embodiment, contact portion 21 is a curved portion configured to hook around the overhand strand. Contact portion 21 may also include, for example, a clamp or other device that enables contact portion 21 to releasably hold onto the overhead strand so that monitoring device 10 may be suspended from the overhead strand. In the illustrated embodiment, attachment device 20 is connected to second housing portion 16, but attachment device 20 may also be connected to first housing portion 14.

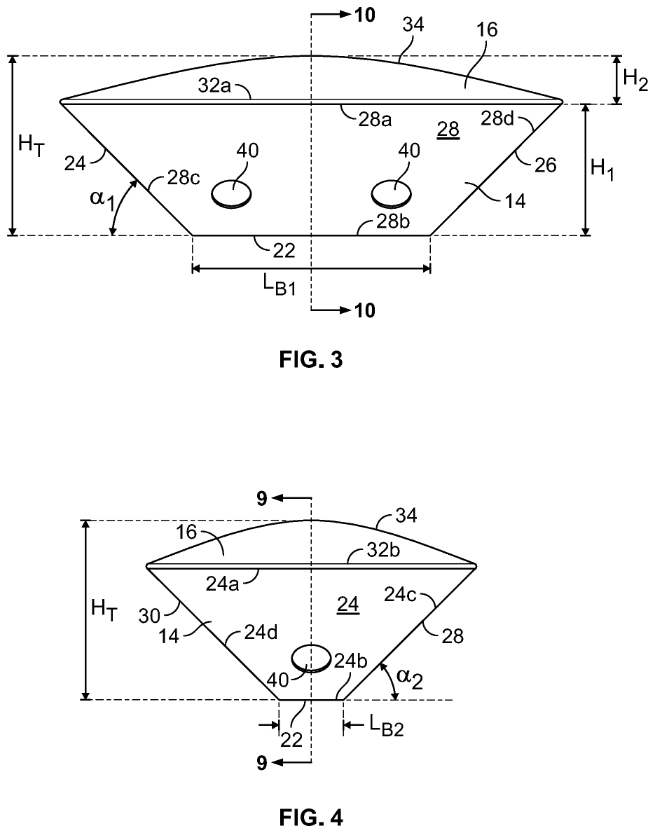

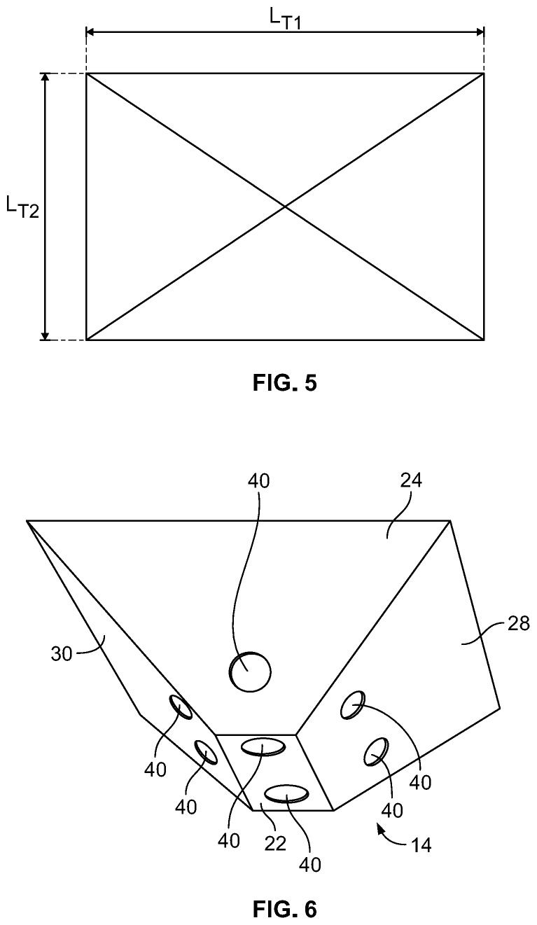

FIGS. 3 to 5 show the shape of an example embodiment of housing 12 in more detail. In the illustrated embodiment, first housing portion 14 includes a bottom surface 22 and four side surfaces 24, 26, 28 and 30 that are angled outwardly from bottom surface 22 to form a trapezoid shape when viewed from front, back or either side. For simplicity, the side surfaces will hereafter be referred to as left surface 24, right surface 26, front surface 28 and rear surface 30, but it should be understood that any side surface could be considered the front surface and those terms are merely taken from the reference point of FIG. 3 as the front view. In an alternative embodiment, bottom surface 22 may be an edge where one or more of side surfaces 24, 26, 28 and 30 meet as opposed to a separate flat surface. One of ordinary skill in the art will also understand that the number of side surfaces 24, 26, 28 and 30 is not limited to four. It is also contemplated that the edges between the side surfaces may be rounded to give the appearance of a single continuous surface around first housing portion 14, but that in such case the multiple side surfaces facing different directions are still present.

FIG. 3 shows a side view of front surface 28. As illustrated, front surface 28 has a trapezoid shape, preferably an equilateral trapezoid shape. In the illustrated embodiment, rear surface 30 would appear identical to front surface 28 in FIG. 3. In an example embodiment, the top edge 28a of front surface 28 has a length L_{T1} of about 20 to 24 inches (e.g., about 21 to 23 inches, about 21.5 to 22.5 inches, about 22.368 inches), the bottom edge 28b where front surface 28 meets bottom surface 22 has a length L_{B1} of about 9 to 13 inches (e.g., about 10 to 12 inches, about 10.5 to 11.5 inches, about 10.827 inches), and the side edges 28c, 28d where front surface 28 meets left surface 24 and right surface 26 have a horizontal height H₁ of about 4 to 8 inches (e.g., about 5 to 7 inches, about 5.5 to 6.5 inches, about 5.906 inches). Left surface 24 and right surface 26 are angled at an angle α₁ of about 35° to 55° (e.g., about 40° to 50°, about 45°) with respect to top edge 28a and bottom edge 28b, giving front surface 28 its trapezoid shape.

FIG. 4 shows a side view of left surface 24. As illustrated, left surface 24 has a trapezoid shape, preferably an equilateral trapezoid shape. In the illustrated embodiment, right surface 26 would appear identical to left surface 24 in FIG. 4. In an example embodiment, the top edge 24a of left surface 24 has a length L_{T2} of about 13 to 17 inches (e.g., about 14 to 16 inches, about 14.5 to 15.5 inches, about 14.961 inches), the bottom edge 24b of left surface 24 where left surface 24 meets bottom surface 22 has a length L_{B2} of about 1 to 5 inches (e.g., about 2 to 4 inches, about 2.5 to 3.5 inches, about 3.150 inches), and the side edges 24c, 24d where left surface 24 meets front surface 28 and rear surface 30 have a horizontal height H₁ of about 4 to 8 inches (e.g., about 5 to 7 inches, about 5.5 to 6.5 inches, about 5.906 inches). Front surface 28 and rear surface 30 are angled at an angle α₂ of about 35° to 55° (e.g., about 40° to 50°, about 45°) with respect to top edge 24a and bottom edge 24b, giving left surface 24 its trapezoid shape.

In the illustrated embodiment, second housing portion 16 has a flat bottom surface 32 and a curved upper surface 34 when viewed from the front, rear and sides. In the front view of FIG. 3, edge 32a where bottom surface 32 meets top surface 34 has a length L_{T1} of about 20 to 24 inches (e.g., about 21 to 23 inches, about 21.5 to 22.5 inches, about 22.368 inches). In the side view of FIG. 4, edge 32b where bottom surface 32 meets top surface 34 has a length L_{T2} of about 13 to 17 inches (e.g., about 14 to 16 inches, about 14.5 to 15.5 inches, about 14.961 inches). Top surface 34 may be curved in at least one of the front and side views, at least two opposite side views (front and back or both sides), or all of the front, back and side views, so that environmental elements such as rain, snow and ice do not accumulate on top of housing 12 and instead slide off of second housing portion 16. In the illustrated embodiment, second housing portion 16 has a height H₂ of about 0.1 to 4 inches (e.g., about 1 to 3 inches, about 1.5 to 2.5 inches, about 2.126 inches), making the total height H_{T} of housing 12 when first housing portion 14 is combined with second housing portion 16 about 6 to 10 inches (e.g., about 7 to 9 inches, about 7.5 to 8.5 inches, about 8.031 inches).

The material used to form the surfaces of first housing portion 14 and second housing portion 16 should preferably be able to withstand environmental elements such as rain, snow and ice. In an embodiment, housing 12 may be formed of metal or plastic material. Those of ordinary skill in the art will recognize other materials that may be used. In an embodiment, housing 12 is formed of aluminum.

As illustrated, the opposite front and rear surfaces 28, 30 are longer than the opposite left and right surfaces 24, 26. The bottom surface 22 shown is at least twice, preferably over three times, as long along front edge 28b as it is along left edge 24b. Front edge 28b is also over 1.5×, preferably 1.5× to 2×, as large as the height H₁ of first housing portion 14 and is longer than the total height H_{T} of housing 12 with first housing portion 14 attached to second housing portion 16. Top edge 28a of front surface 28 is also about 1.5× longer, preferably over 1.25× or between 1.25× and 2× longer, than top edge 24a of left surface 24. By manufacturing housing 12 in this manner, housing 12 achieves a short and stout design that has been found to be steady, balanced and wind resistant, while still achieving desired sensor angles for a wide field of view.

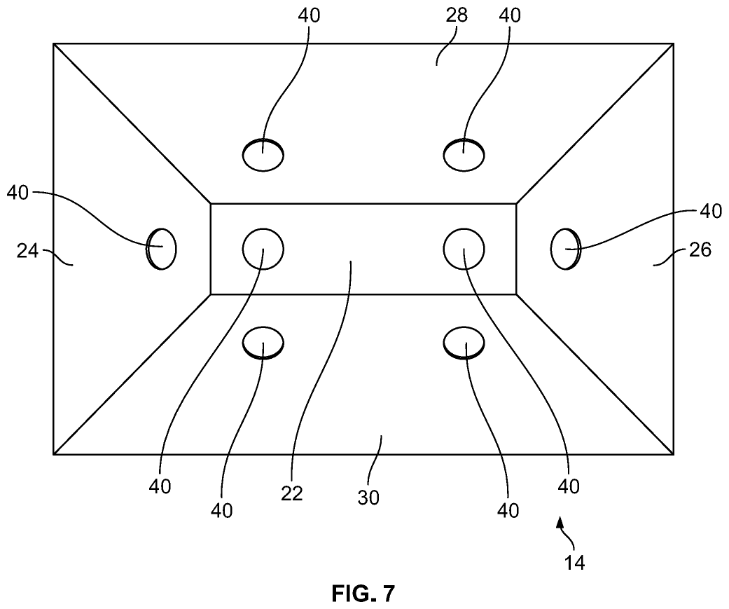

FIGS. 6 and 7 show bottom views of first housing portion 14 of housing 12. In the illustrated embodiment, first housing portion 14 includes eight apertures 40. Two apertures 40 are located on bottom surface 22, two apertures 40 are located on front surface 28, two apertures 40 are located on rear surface 30, one aperture 40 is located on left surface 24, and one aperture 40 is located on right surface 26. It should be understood by one of ordinary skill in the art that more or less apertures 40 may be located on one or more of bottom surface 22, front surface 28, rear surface 30, left surface 24 and right surface 26. In an alternative embodiment, bottom surface 22 may be an edge where one or more of side surfaces 24, 26, 28 and 30 meet as opposed to a separate flat surface, wherein bottom surface 22 does not include an aperture. In another alternative embodiment, not all of bottom surface 22, front surface 28, rear surface 30, left surface 24 and right surface 26 include an aperture 40.

Each aperture 40 is configured to receive a sensor 42 from inner space 18 so that the sensors 42 are configured to take readings outside of housing 12. In the illustrated embodiment, each aperture has a diameter of about 1 to 2.5 inches (e.g., 1.728 inches). With front surface 28, rear surface 30, left surface 24 and right surface 26 angled as shown, eight sensors 42 positioned at each of the eight apertures are configured for a wide angle of view covering every side and bottom of first housing portion 14.

In an embodiment, the plurality of sensors 42 may be cameras. By positioning cameras in some or all of the eight apertures 40, and by hanging monitoring device 10 from an overhead cable using an attachment device 20, a user may be provided with a bird's eye view from monitoring device 10 that covers a wide field of view of the surroundings below and to the side. In an embodiment, the sensors may be connected to an internal web server and/or external video management server.

In other embodiments, sensors 42 may be, for example, particle counters, radiation sensors, infrared sensors, radar sensors, license plate recognition sensors, Bluetooth sensors, motion sensors, photocell sensors, bi-directional audio sensors, PIR sensors, temperature sensors, humidity sensors, GPS sensors and/or other sensors. Any combination of sensors 42 may be used with one or more aperture 40. Housing 12 enables any number of sensors 42 to be removably attached via inner space 18, so a user may mix any combination of sensors to give monitoring device 10 any number of different functions. In an embodiment, the sensors 42 may all integrate as well as interact on any combination of sensors 42, trigger alarms and events as well as contacts and relays.

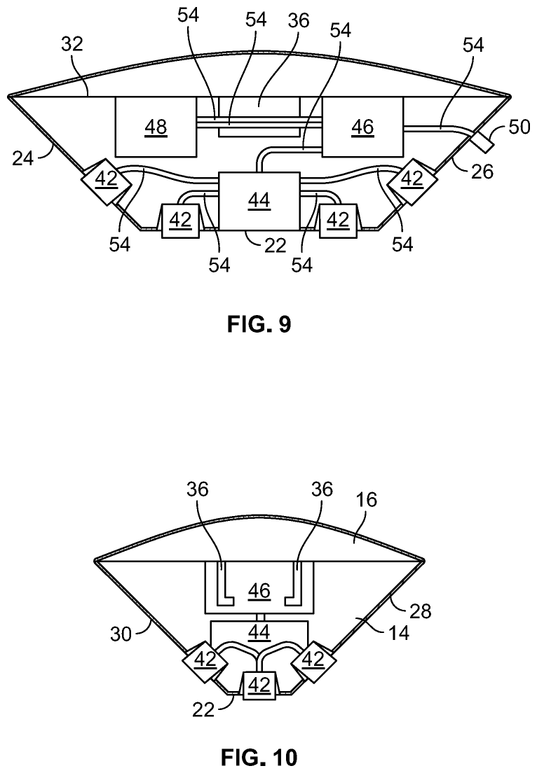

In an embodiment, housing 12 may be customizable by enabling one or more sensor 42 to be removeably attached inside inner space 18 at each aperture 40. In the illustrated embodiment, each sensor 42 slides into an aperture 40 from inner space 18 while second housing portion 16 is removed from first housing portion 14. Each sensor 42 is then held in place within inner space 18, for example, using a clamp or other fixture that attaches to the sensor casing. In the illustrated embodiment shown in FIGS. 9 and 10, part of the sensor casing has a wider diameter that prevents sensor 42 from sliding through aperture 40 from inside inner space 18. In an embodiment, the sensors 42 may be gasketed (e.g., encircled with a rubber gasket to seal aperture 40) and may attach via a clasp or screw on a connector from inside through penetration and may be used on any surface of the enclosure.

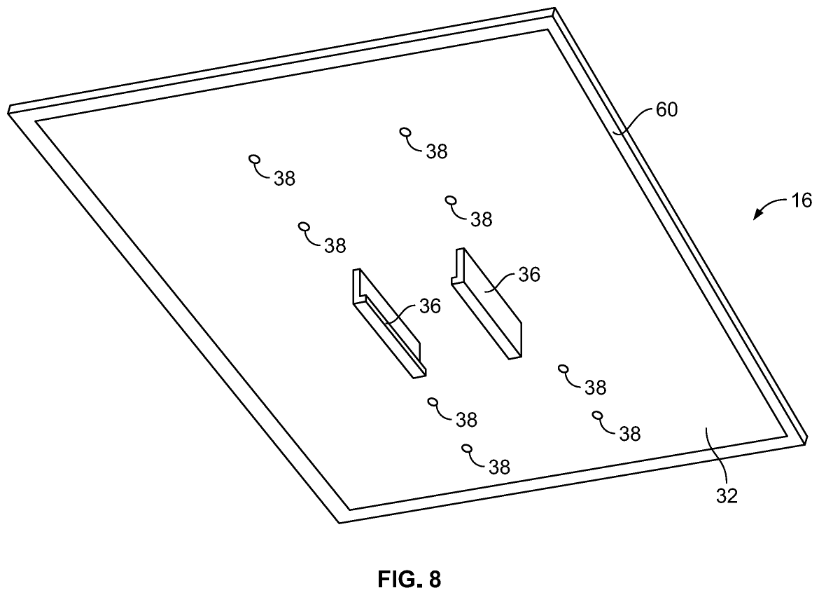

FIG. 8 shows bottom surface 32 of second housing portion 16. In the illustrated embodiment, bottom surface 32 includes two slide rails 36 and eight apertures 38 for standoffs. More or less slide rails 36 and apertures 38 may be included. The slide rails 36 may be used, for example, to hold components of monitoring device 10 or to organize any wiring 54 inside inner space 18, as explained in more detail below. The apertures 38 may be used, for example, to attach any component held within inner space 18 to bottom surface 32, as explained in more detail below. In an embodiment, the components may be attached via aluminum mounting plates that serve as both mounts for the components and to dissipate heat generated from the components. Inner space 18 may further include ventilation fans, for example, in which one fan pulls fresh air from outside monitoring device 10 into inner space 18 and another fan pushes air from inner space 18 to the outside of monitoring device 10.

FIGS. 9 and 10 show cross-sectional views of inner space 18 inside housing 12. In the illustrated embodiment, inner space 18 includes the plurality of sensors 42, a sensor control unit 44, a routing unit such as a power over Ethernet (“POE”) unit 46 and a modem 48 (e.g., a cable modem). Those of ordinary skill in the art will recognize that other components may be included inside inner space 18 besides those shown.

In the illustrated embodiment, all of the electrical components located within inner space 18 of housing 12 may be powered via a single communication line, for example, a 48 V DC communication line 74 such as an RG6 wire. In an embodiment, housing 12 includes a female F connector 50, which may be connected to a male F connector of the communication line 74, and the other end of the communication line 74 may be connected to a communication line tap 72 to provide monitoring device 10 with both power and data communication. Those of ordinary skill in the art will recognize that other connectors besides an F connector may be used for connector 50.

POE unit 46 filters the 48 V received from the communication line 74 so that all of the components of monitoring device 10 may be powered. In an embodiment, POE unit 46 provides both data and power to sensor control unit 44 and modem 48 and also acts as a router and firewall between sensor control unit 44 and modem 48. In the illustrated embodiment, POE unit 46 is connected to female F connector 50 and receives the power and data communication from communication line 74. POE unit 46 may have multiple POE outlet ports that may be connected to multiple sensor control units 44. For simplicity, in the illustrated embodiment, all of the sensors 42 are connected to a single sensor control unit 44, so only one of the POE outlet ports on POE unit 46 is used. In an embodiment, a single sensor control unit 44 may be installed and may control all of the sensors 42 in monitoring device 10, regardless of whether the sensors 42 are all the same type. In another embodiment, multiple sensor control units 44 may be installed and connected to different POE outlet ports of POE unit 46 and may be used to control different types of sensors 42 within monitoring device 10.

POE unit 46 also includes one or more power outlets which filter down the 48 V power received from the 48 V DC communication line so that it may be used to power smaller electrical components such as sensor control unit 44 and modem 48. For example, POE unit 46 may have a 12 V DC outlet port and a 5 V DC outlet port. In the illustrated embodiment, modem 48 is connected to the 12 V DC outlet port of POE unit 46 to receive 12 V power.

Modem 48 enables a user to wirelessly communicate with sensor control unit 44, for example, to view images, video and/or data recorded by sensors 42 and/or to remotely control or program sensors 42. In an embodiment, POE unit 46 places sensor control unit 44 in data communication with modem 48 so that data may pass back and forth between sensor control unit 44 and modem 48. In the illustrated embodiment, modem 48 has an outlet port connected to a DC filter 52 and then to POE unit 46 so that only data and not power is delivered back to POE unit 46 from modem 48. Modem 48 also enables monitoring device to be used as a wireless hotspot without accessing the images, video and/or data recorded by sensors 42.

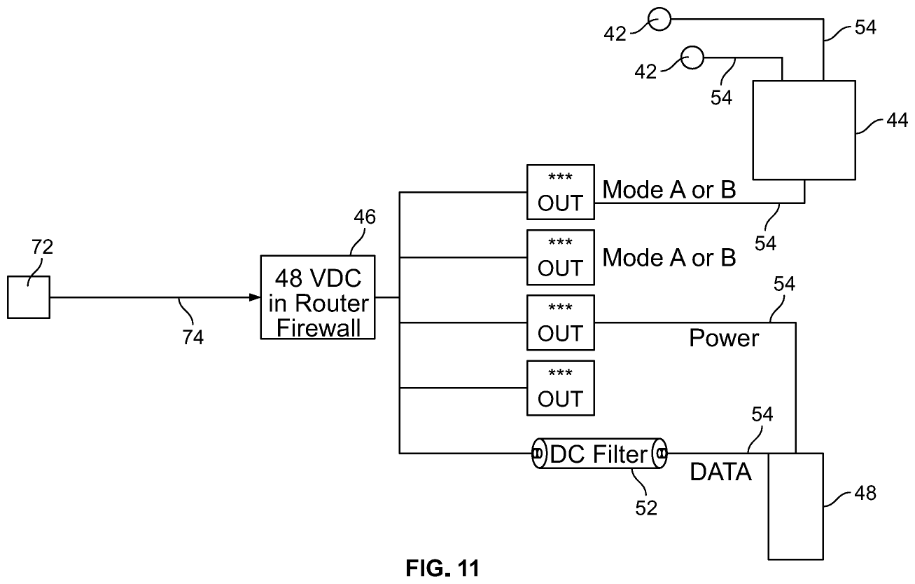

FIG. 11 illustrates an example embodiment of an electrical diagram showing how power and data from the 48 V DC communication line 74 may be directed to the electrical components within inner space 18 of housing 12 via wiring 54. As illustrated, power and data may be routed to POE unit 46, which is connected to sensor control unit 44 via one of the POE outlet ports. A second sensor control unit 44 may be connected to the second POE outlet port. Modem 48 receives power from POE unit 46 via a 12 V DC outlet port, and sends data back to POE unit 46 after the data has been filtered through a DC filter 52 to remove DC power. A second 5 V DC outlet port enables additional electrical components to be added to monitoring device 10. As illustrated, the wiring 54 enables sensor control unit 44 to be in data communication with modem 48 via POE unit 46 so that data may pass back and forth between sensor control unit 44 and modem 48.

In the illustrated embodiment of FIGS. 9 and 10, POE unit 46 and modem 48 are attached to bottom surface 32 of second housing portion 16, while sensor control unit 44 is attached to the inside of bottom surface 22 of first housing portion 14. It should be understood, however, that any one or more of sensor control unit 44, POE unit 46 and modem 48 may be attached to bottom surface 32 of second housing portion 16 or any other surface inside inner space 18. POE unit 46 and modem 48 are attached to bottom surface 32 of second housing portion 16, for example, by being screwed into apertures 38, but those of ordinary skill in the art will recognize that other attachments are possible.

With POE unit 46 and modem 48 attached to bottom surface 32 of second housing portion 16, a user may lift second housing portion 16 off of first housing portion 14 and change the sensor control unit 44 and/or sensors 42 without disrupting components of monitoring device 10 that will remain regardless of the type of sensors 42 used. The use of bottom surface 32 of second housing portion 16 to hold components of monitoring device 10 therefore makes it easier to customize the sensors 42 in the monitoring device 10 according to the user's preference without disrupting common components. Slide rails 36 may also organize wiring 54 in monitoring device, making it easier for the user to change the sensor control unit 44 and/or sensors 42 without disrupting wiring 54.

Those of ordinary skill in the art will recognize that first housing portion 14 and second housing portion 16 may be removeably attached to each other in a variety of ways, for example, using detachable clamps or other attachment mechanisms. Since inner space 18 of housing 12 includes electrical components, second housing portion 16 should be sealed to first housing portion 14 in a way that prevents water from entering inner space 18. In an embodiment, the outer edges 32a, 32b, etc. of bottom surface 32 of second housing portion 16 and/or the top edges 24a, 28a, etc. of first housing portion 14 may include a weather strip 60, for example, a foam strip that lines the edges. When second housing portion 16 is attached to first housing portion 14, the edges press against the weather strip 60 and provide a watertight seal. Those of ordinary skill in the art will recognize other ways to seal inner space 18 from water. In an embodiment, first housing portion 12 and second housing portion 14 may be sealed via a gasket, and second housing portion 14 may overhang first housing portion 12 by, for example, about ¾ inch to allow water runoff.

FIG. 12 illustrates a monitoring device 10 hanging from an overhead strand 70 that also holds communication cables 78. As illustrated, monitoring device 10 is connected to a communication line tap 72 by a 48 V DC communication line 74. FIG. 12 illustrates several advantages of monitoring device 10. For example, monitoring device 10 may be hung from any strand 70 in proximity to a communication line tap 72. Setup of monitoring device 10 on strand 70 simply requires the user to connect the communication line 74 to the communication line tap 72 and does not require the user to be near any power lines 76. The owner of strand 70 is also free to hang monitoring device 10 without being required to obtain permits that would be required with using the utility pole itself or other lines.

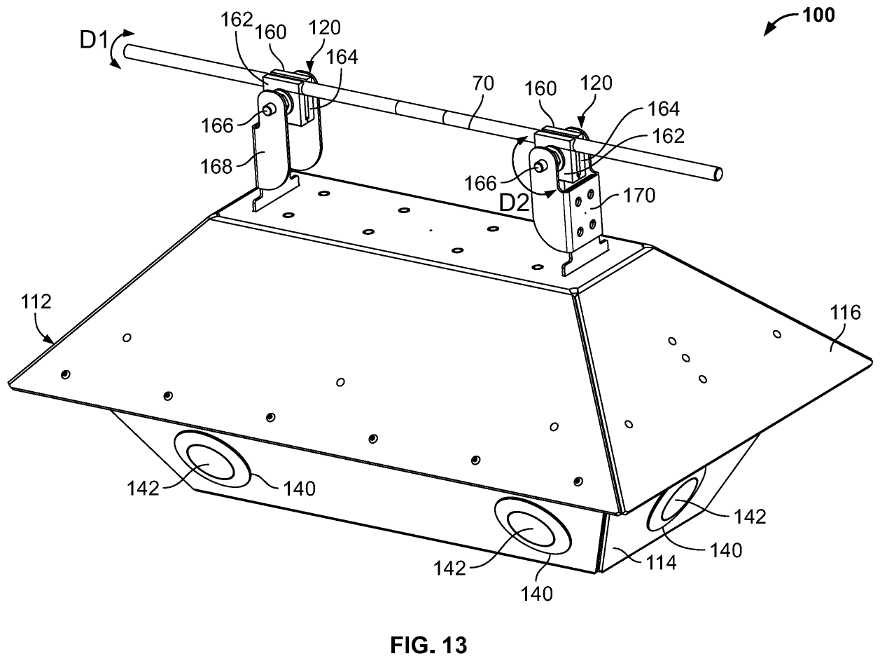

FIGS. 13 to 17 illustrate an alternative embodiment of a monitoring device 100 according to the present disclosure. It should be understood that any of the elements discussed above with respect to monitoring device 10 may also be added to or interchanged with elements of monitoring device 100, and that any of the elements discussed below with respect to monitoring device 100 may also be added to or interchanged with elements of monitoring device 10.

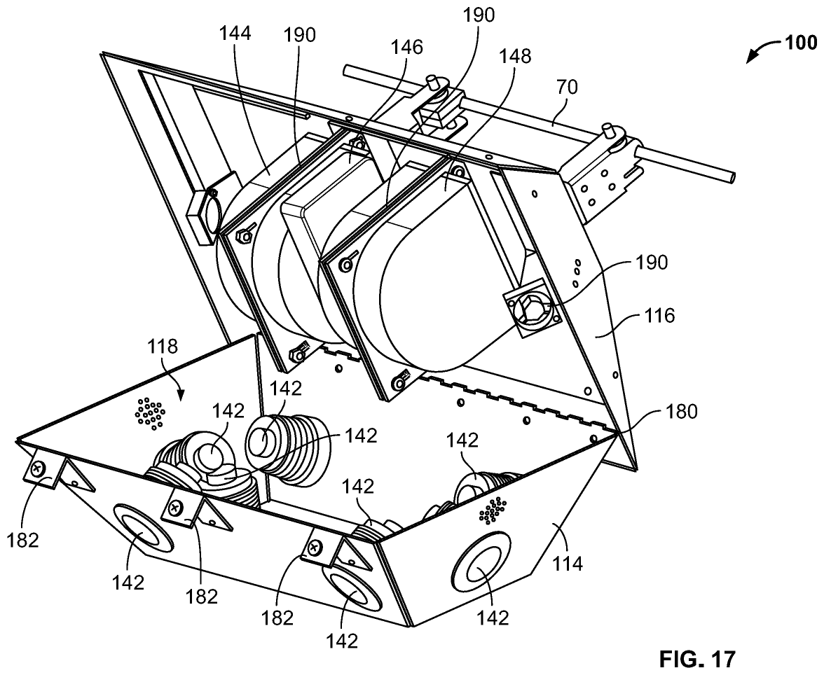

As illustrated, monitoring device 100 includes a housing 112 having a first or lower housing portion 114 and a second or upper housing portion 116. FIGS. 13 to 16 show first housing portion 114 and second housing portion 116 removeably attached to enclose an inner space 118, while FIG. 17 shows second housing portion 116 detached from first housing portion 114 to reveal inner space 118 so that inner space 118 may be accessed by a user. As with monitoring device 10 above, monitoring device 100 includes an attachment device 120 enabling housing 112 to hang from an overhead strand 70 positioned approximately horizontally across one or more utility poles. The overhead strand 70 is typically, for example, a galvanized steel cable from which communication cables are hung and which is located beneath the power lines on the utility pole.

Attachment device 120 enables housing 112 to hang from an overhead strand 70. In the illustrated embodiment, attachment device 120 includes at least one contact portion 160 that is configured to contact and thereby attach to the overhead strand 70. In the illustrated embodiment, contact portion 160 is a clamp including a first clamping portion 162 and a second clamping portion 164 that may be tightened around the overhead strand by tightening bolt 166 to releasably hold onto the overhead strand so that monitoring device 100 may be suspended from the overhead strand 70. By loosening bolt 166, contact portion 160 may be released from the overhead strand 70. Attachment device 120 further includes a first bracket 168 and a second bracket 170, which each attach to a contact portion 160 to couple the contact portions 160 to second housing portion 116. In the illustrated embodiment, attachment device 120 is attached to the top surface 134 of second housing portion 116, but may also be attached to housing 112 at other locations.

With attachment device 120 illustrated in FIG. 13, there are four pivot points, giving monitoring device 100 flexibility while hanging from overhead strand 70. Each of the to contact portions 160 shown may pivot around overhead strand 70 in the direction D₁, while first bracket 168 and second bracket 170 may each pivot around a tightening bolt 166 the directions D₂. The pivoting allows monitoring device 100 to be balanced or adjusted regardless of the orientation of an overhead strand to which is attaches.

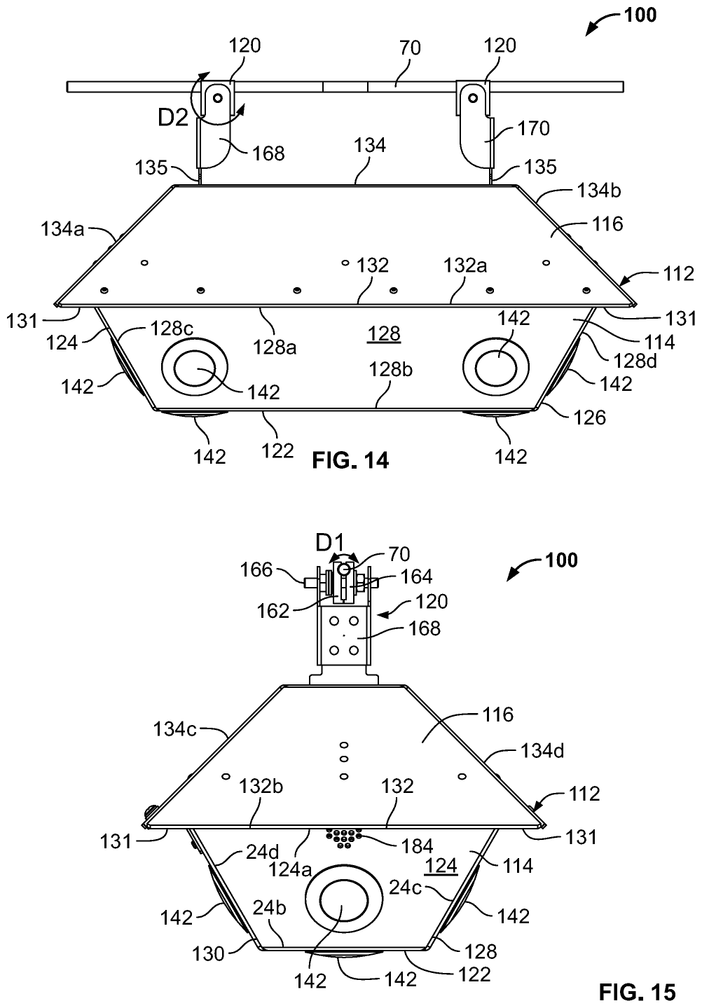

FIGS. 14 to 16 show the shape of an example embodiment of housing 112 in more detail. In the illustrated embodiment, first housing portion 14 includes a bottom surface 122 and four side surfaces 124, 126, 128 and 130 that are angled outwardly from bottom surface 122 to form a trapezoid shape when viewed from front, back or either side. For simplicity, the side surfaces will hereafter be referred to as left surface 124, right surface 126, front surface 128 and rear surface 130, but it should be understood that any side surface could be considered the front surface and those terms are merely taken from the reference point of FIG. 14 as the front view. In an alternative embodiment, bottom surface 122 may be an edge where one or more of side surfaces 124, 126, 128 and 130 meet as opposed to a separate flat surface. One of ordinary skill in the art will also understand that the number of side surfaces 124, 126, 128 and 130 is not limited to four. It is also contemplated that the edges between the side surfaces may be rounded to give the appearance of a single continuous surface around first housing portion 114, but that in such case the multiple side surfaces facing different directions are still present.

FIG. 14 shows a side view of front surface 128. As illustrated, front surface 28 has a trapezoid shape, preferably an equilateral trapezoid shape. In the illustrated embodiment, rear surface 130 would appear identical to front surface 128 in FIG. 14. The surfaces and edges 128a, 128b, 128c, 128d of monitoring device 100 may be dimensioned, for example, similar to the corresponding surfaces and edges of monitoring device 10 discussed above.

FIG. 15 shows a side view of left surface 124. As illustrated, left surface 124 has a trapezoid shape, preferably an equilateral trapezoid shape. In the illustrated embodiment, right surface 126 would appear identical to left surface 124 in FIG. 15. The surfaces and edges 124a, 124b, 124c, 124d of monitoring device 100 may be dimensioned, for example, similar to the corresponding surfaces and edges of monitoring device 10 discussed above.

In an embodiment, the overall height of housing 112 (including first housing portion 114 and second housing portion 116) is between 4 and 10 inches, or between 6 and 8 inches, or about 7 inches, or about 6.7 inches. In an embodiment, the height of attachment mechanism 120 is between 2 and 4 inches, or about 3 inches, or about 2.9 inches.

In the illustrated embodiment, second housing portion 116 has a flat bottom surface 132 and an upper surface 134 having angled portions 134a, 134b, 134c and 134d so that environmental elements such as rain, snow and ice do not accumulate on top of housing 112 and instead slide off of second housing portion 116. In an embodiment, the flat portion of upper surface 134 includes protrusions 135 to allow a connection with attachment mechanism 120, for example, by screwing a protrusion 135 into first bracket 168 and second bracket 170. In an embodiment, upper surface 134 may be curved similar to upper surface 34 of monitoring device 10 discussed above. In the illustrated embodiment, edge 132a of bottom surface 132 is longer than edge 128a of front surface 128, and edge 132b of bottom surface 132 is longer than edge 124a of left surface 124 (with the same dimensions in the opposite views not shown), creating an overhang 131 from the front, rear and side views to cause environmental elements such as rain, snow and ice to run off of second housing portion 116 without contacting first housing portion 114. In an embodiment, the length of edge 132a is between 14 and 20 inches, or between 16 and 18 inches, or about 17 inches, or about 17.4 inches, which the length of edge 132b is between 7 to 13 inches, or between 9 to 11 inches, or about 10 inches, or about 10.3 inches.

The material used to form the surfaces of first housing portion 114 and second housing portion 116 should preferably be able to withstand environmental elements such as rain, snow and ice. In an embodiment, housing 112 may be formed of metal or plastic material. Those of ordinary skill in the art will recognize other materials that may be used. In an embodiment, housing 112 is formed of aluminum.

As illustrated, the opposite front and rear surfaces 128, 130 are longer than the opposite left and right surfaces 124, 126. The bottom surface 122 shown is at least twice, or over three times, as long along front edge 128b as it is along left edge 124b. Front edge 128b is also over 1.5×, or 1.5× to 2×, or over 2×, or over 3×, as large as the height of first housing portion 114 and is longer than the total height of housing 112 with first housing portion 114 attached to second housing portion 116. Top edge 128a of front surface 128 is also about 1.5× longer, or over 1.25× or between 1.25× and 2× longer, than top edge 124a of left surface 124. By manufacturing housing 112 in this manner, housing 112 achieves a short and stout design that has been found to be steady, balanced and wind resistant, while still achieving desired sensor angles for a wide field of view.

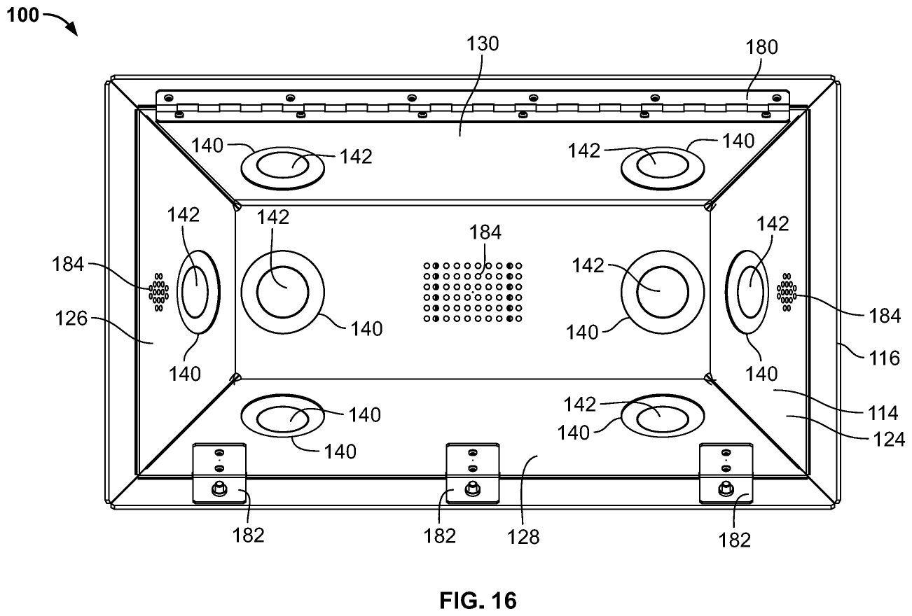

FIG. 16 shows a bottom view of first housing portion 114 of housing 112. In the illustrated embodiment, first housing portion 114 includes eight apertures 140 including sensors 142. Two apertures 140 are located on bottom surface 122, two apertures 140 are located on front surface 128, two apertures 140 are located on rear surface 130, one aperture 140 is located on left surface 124, and one aperture 140 is located on right surface 126. It should be understood by one of ordinary skill in the art that more or less apertures 140 may be located on one or more of bottom surface 122, front surface 128, rear surface 130, left surface 124 and right surface 126. In an alternative embodiment, bottom surface 122 may be an edge where one or more of side surfaces 124, 126, 128 and 130 meet as opposed to a separate flat surface, wherein bottom surface 122 does not include an aperture. In another alternative embodiment, not all of bottom surface 122, front surface 128, rear surface 130, left surface 124 and right surface 126 include an aperture 140.

Each aperture 140 is configured to receive a sensor 142 from inner space 118 so that the sensors 142 are configured to take readings outside of housing 112. In the illustrated embodiment, each aperture has a diameter of about 1 to 2.5 inches (e.g., 1.728 inches). With front surface 128, rear surface 130, left surface 124 and right surface 126 angled as shown, eight sensors 142 positioned at each of the eight apertures are configured for a wide angle of view covering every side and bottom of first housing portion 14.

In an embodiment, the plurality of sensors 142 may be cameras. By positioning cameras in some or all of the eight apertures 140, and by hanging monitoring device 100 from an overhead cable 70 using an attachment device 120, a user may be provided with a bird's eye view from monitoring device 100 that covers a wide field of view of the surroundings below and to the side. In an embodiment, the sensors may be connected to an internal web server and/or external video management server.

In other embodiments, sensors 142 may be, for example, particle counters, radiation sensors, infrared sensors, radar sensors, license plate recognition sensors, Bluetooth sensors, motion sensors, photocell sensors, bi-directional audio sensors, PIR sensors, temperature sensors, humidity sensors, GPS sensors and/or other sensors. Any combination of sensors 142 may be used with one or more aperture 140. Housing 112 enables any number of sensors 142 to be removably attached via inner space 18, so a user may mix any combination of sensors to give monitoring device 100 any number of different functions. In an embodiment, the sensors 142 may all integrate as well as interact on any combination of sensors 142, trigger alarms and events as well as contacts and relays.

In an embodiment, housing 112 may be customizable by enabling one or more sensor 142 to be removeably attached inside inner space 118 at each aperture 140. In the illustrated embodiment, each sensor 142 slides into an aperture 140 from inner space 118 while second housing portion 116 is removed from first housing portion 114. Each sensor 142 is then held in place within inner space 118, for example, using a clamp or other fixture that attaches to the sensor casing. In an embodiment, part of the sensor casing has a wider diameter that prevents sensor 142 from sliding through aperture 140 from inside inner space 118. In an embodiment, the sensors 142 may be gasketed (e.g., encircled with a rubber gasket to seal aperture 140) and may attach via a clasp or screw on a connector from inside through penetration and may be used on any surface of the enclosure.

FIG. 17 shows first housing portion 114 and second housing portion 116 rotated open to reveal inner space 118. In the illustrated embodiment, one or both of first housing portion 114 and second housing portion 116 may be rotated via a hinge 180 attached to a side surface of each of first housing portion 114 and second housing portion 116. When closed, first portion 114 and second portion 116 may be secured to each other by tightening brackets 182 on the opposite or another side of hinge 180.

In the illustrated embodiment, first portion 114 includes vents 184 to dissipate heat generated from electrical components within inner space 118. Inner space 118 may further include ventilation fans, for example, in which one fan pulls fresh air from outside monitoring device 100 into inner space 118 via a vent 184 and the other fan pushes air from inner space 118 to the outside of monitoring device 100 via a vent 184. Since the vents 184 are provided on first portion 114 below the overhang provided by second housing portion 116, water runoff does not enter the vents 184.

As illustrated in FIG. 17, inner space 118 may include a plurality of sensors 142, a sensor control unit 144, a routing unit such as a power over Ethernet (“POE”) unit 146 and a modem 148 (e.g., a cable modem). Those of ordinary skill in the art will recognize that other components may be included inside inner space 18 besides those shown. Control unit 144, routing unit 146 and modem 148 may be used as described above with respect to control unit 44, routing unit 46 and modem 48.

In the illustrated embodiment, all of the electrical components located within inner space 118 of housing 112 may be powered via a single communication line, for example, a 48 V DC communication line such as an RG6 wire. As with monitoring device 10 above, housing 112 may include a female F connector, which may be connected to a male F connector of the communication line 74, and the other end of the communication line 74 may be connected to a communication line tap 72 to provide monitoring device 10 with both power and data communication. Those of ordinary skill in the art will recognize that other connectors besides an F connector may be used for connector.

In the illustrated embodiment, sensor control unit 144, POE unit 146 and modem 148 are attached to second housing portion via brackets 190 and rotate into an open space of first housing portion 114 when housing 112 is closed. It should be understood, however, that any one or more of sensor control unit 144, POE unit 146 and modem 148 may be attached to any surface inside inner space 118.

With sensor control unit 144, POE unit 146 and modem 148 attached to second housing portion 116, a user may lift second housing portion 116 off of first housing portion 114 and change the sensors 42 without disrupting components of monitoring device 100 that will remain regardless of the type of sensors 142 used. The use of second housing portion 116 to hold components of monitoring device 100 therefore makes it easier to customize the sensors 142 in the monitoring device 100 according to the user's preference without disrupting common components.

Monitoring device 100 may be attached to an overhead strand in the same way as monitoring device 10 as illustrated in FIG. 12, and may be connected to a communication line tap 72 by a 48 V DC communication line 74.

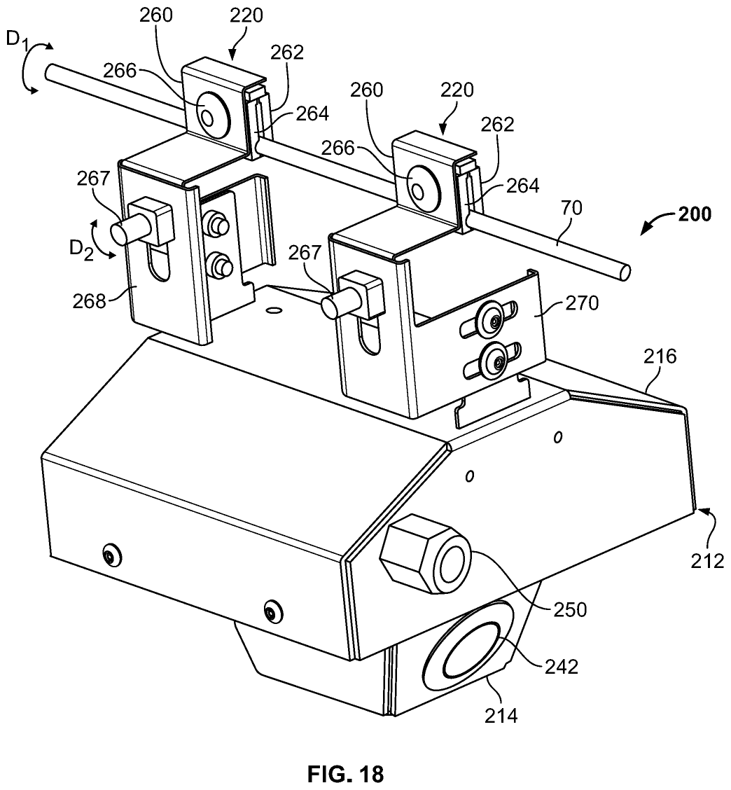

FIGS. 18 to 23 illustrate an alternative embodiment of a monitoring device 200 according to the present disclosure. It should be understood that any of the elements discussed above with respect to monitoring device 10 or 100 may also be added to or interchanged with elements of monitoring device 200, and that any of the elements discussed below with respect to monitoring device 200 may also be added to or interchanged with elements of monitoring device 10 or 100.

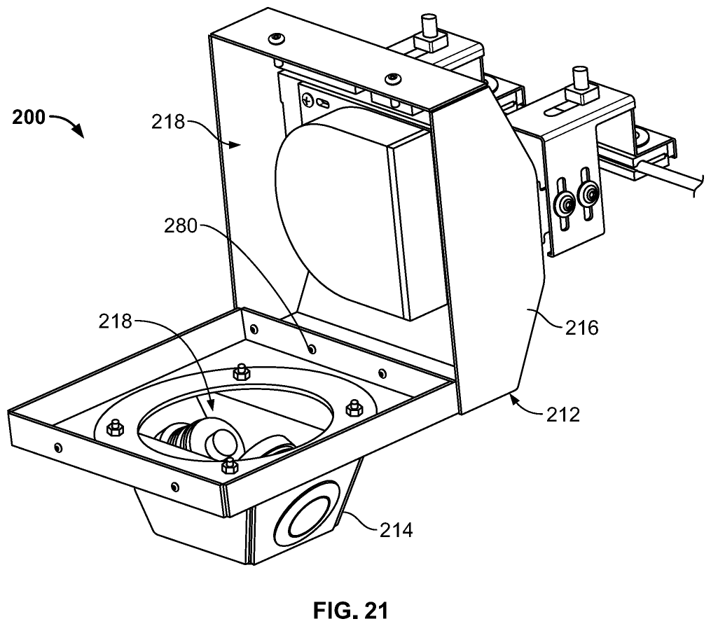

As illustrated, monitoring device 200 includes a housing 212 having a first or lower housing portion 214 and a second or upper housing portion 216. FIGS. 18 to 20 show first housing portion 214 and second housing portion 216 removeably attached to enclose an inner space 218, while FIG. 21 shows second housing portion 216 lifted from first housing portion 214 to reveal inner space 218 so that inner space 218 may be accessed by a user. Similar to monitoring devices 10 and 100 discussed above, monitoring device 200 includes an attachment device 220 enabling housing 212 to hang from an overhead strand 70 positioned approximately horizontally across one or more utility poles.

Attachment device 220 enables housing 212 to hang from an overhead strand 70. In the illustrated embodiment, attachment device 220 includes at least one contact portion 260 that is configured to contact and thereby attach to the overhead strand 70. In the illustrated embodiment, contact portion 260 is a clamp including a first clamping portion 262 and a second clamping portion 264 that may be tightened around the overhead strand by tightening bolt 266 to releasably hold onto the overhead strand so that monitoring device 200 may be suspended from the overhead strand 70. By loosening bolt 266, contact portion 260 may be released from the overhead strand 70. Attachment device 220 further includes a first bracket 168 and a second bracket 270, which each attach to a contact portion 260 to couple the contact portions 260 to second housing portion 216. In the illustrated embodiment, attachment device 220 is attached to the top surface 234 of second housing portion 216, but may also be attached to housing 212 at other locations.

With the attached device 220 illustrated in FIG. 13, there are four pivot points, giving monitoring device 200 flexibility while hanging from overhead strand 70. Each of the to contact portions 260 shown may pivot around overhead strand 70 in the direction D₁, while first bracket 268 and second bracket 270 may each pivot around a tightening bolt 267 the directions D₂. The pivoting allows monitoring device 200 to be balanced or adjusted regardless of the orientation of an overhead strand to which is attaches.

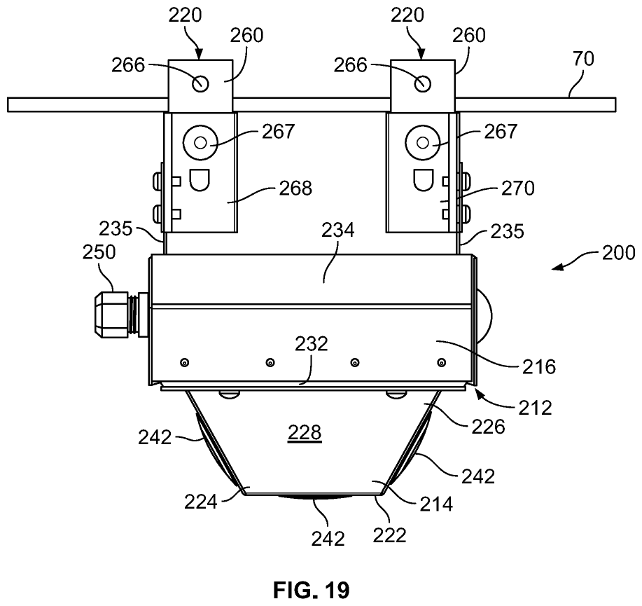

Similar to monitoring devices 10 and 100 above, first housing portion 214 includes a bottom surface 222 and four side surfaces 224, 226, 228 and 230, one or more of which may be angled outwardly from bottom surface 222 to form a trapezoid shape when viewed a side. For simplicity, the side surfaces will hereafter be referred to as left surface 224, right surface 226, front surface 228 and rear surface 230, but it should be understood that any side surface could be considered the front surface and those terms are merely taken from the reference point of FIG. 19 as the front view. In an alternative embodiment, bottom surface 222 may be an edge where one or more of side surfaces 224, 226, 228 and 230 meet as opposed to a separate flat surface. One of ordinary skill in the art will also understand that the number of side surfaces 224, 226, 228 and 230 is not limited to four. It is also contemplated that the edges between the side surfaces may be rounded to give the appearance of a single continuous surface around first housing portion 214, but that in such case the multiple side surfaces facing different directions are still present.

FIG. 19 shows a side view of front surface 228. As illustrated, front surface 228 has a trapezoid shape, preferably an equilateral trapezoid shape. In the illustrated embodiment, rear surface 230 would appear identical to front surface 228 in FIG. 19.

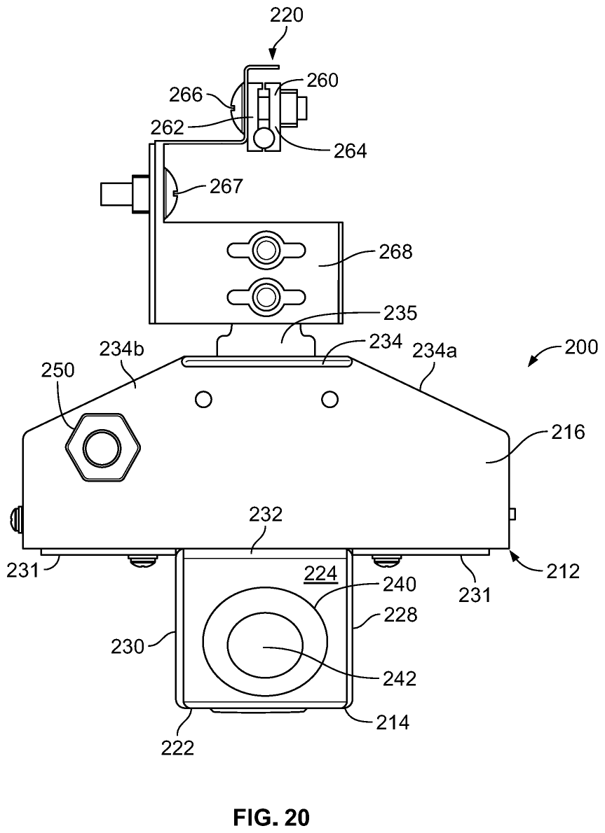

FIG. 20 shows a side view of left surface 224. In the illustrated embodiment, left surface 224 has a square shape, but left surface 224 may also have a trapezoid shape similar to left surface 24 above. In the illustrated embodiment, right surface 226 would appear identical to left surface 224 in FIG. 20.

As illustrated in FIG. 20, second housing portion 216 has a flat bottom surface 232 and an upper surface 234 having angled portions 234a and 234b when viewed from the side so that environmental elements such as rain, snow and ice do not accumulate on top of housing 212 and instead slide off of second housing portion 216. In an embodiment, the flat portion of upper surface 234 includes protrusions 235 to allow a connection with attachment mechanism 220, for example, by screwing a protrusion 235 into first bracket 268 and second bracket 270. In different embodiments, top surface 234 may be angled or curved in at least one of the front and side views, at least two opposite side views (front and back or both sides), or all of the front, back and side views. As illustrated in FIGS. 19 and 20, the length of second housing portion 216 from front to back and side to side is longer than the corresponding lengths of first housing portion 214, enabling second housing portion 216 to create an overhang 231 to cause environmental elements such as rain, snow and ice to run off of second housing portion 216 without contacting first housing portion 214.

The material used to form the surfaces of first housing portion 214 and second housing portion 216 should preferably be able to withstand environmental elements such as rain, snow and ice. In an embodiment, housing 212 may be formed of metal or plastic material. Those of ordinary skill in the art will recognize other materials that may be used. In an embodiment, housing 112 is formed of aluminum.

In the illustrated embodiment, first housing portion 214 includes three apertures 240. One aperture 240 is located on bottom surface 222, one aperture 240 is located on left surface 224, and one aperture 240 is located on right surface 226. It should be understood by one of ordinary skill in the art that more or less apertures 240 may be located on one or more of bottom surface 222, front surface 228, rear surface 230, left surface 224 and right surface 226. For example, first housing portion 214 could be structured with eight apertures similar to first housing portion 14 or 114. In an alternative embodiment, bottom surface 222 may be an edge where one or more of side surfaces 224, 226, 228 and 230 meet as opposed to a separate flat surface, wherein bottom surface 222 does not include an aperture.

Each aperture 240 is configured to receive a sensor 242 from inner space 218 so that the sensors 242 are configured to take readings outside of housing 212. With left surface 224 and right surface 226 angled as shown, three sensors 242 positioned at each of the eight apertures are configured for a wide angle of view from first housing portion 214. As with monitoring device 10 and 100 above, the plurality of sensors 242 may be cameras. By positioning cameras in the eight apertures 240, and by hanging monitoring device 210 from an overhead cable using an attachment device 220, a user may be provided with a bird's eye view from monitoring device 200 that covers a wide field of view of the surroundings below and to the side. In other embodiments, sensors 242 may be, for example, particle counters, radiation sensors, infrared sensors, radar sensors, license plate recognition sensors, Bluetooth sensors, motion sensors, photocell sensors, bi-directional audio sensors, PIR sensors, temperature sensors, humidity sensors, GPS sensors and/or other sensors. Any combination of sensors 242 may be used with one or more aperture 240. Housing 212 enables any number of sensors 242 to be removably attached via inner space 218, so a user may mix any combination of sensors to give monitoring device 200 any number of different functions.

As with monitoring device 10 or 100 above, housing 212 may be customizable by enabling one or more sensor 242 to be removeably attached inside inner space 218 at each aperture 240. In the illustrated embodiment, each sensor 242 slides into an aperture 240 from inner space 218 while second housing portion 216 is removed from first housing portion 214. Each sensor 242 is then held in place within inner space 218, for example, using a clamp or other fixture that attaches to the sensor casing. In the illustrated embodiment, part of the sensor casing has a wider diameter that prevents sensor 242 from sliding through aperture 240 from inside inner space 218. In an embodiment, the sensors 242 may be gasketed (e.g., encircled with a rubber gasket to seal aperture 240) and may attach via a clasp or screw on a connector from inside through penetration and may be used on any surface of the enclosure.

FIG. 21 shows second housing portion 216 lifted from first housing portion 214 to reveal inner space 218 so that inner space 218 may be accessed by a user. In an embodiment, second housing portion 216 is rotatably attached to first housing portion 214 by a hinge 280, enabling inner space 218 to be exposed without second housing portion 216 detaching from first housing portion 214. In an alternative embodiment, second housing portion 216 may be detached from first housing portion 214, or inner space 218 may be exposed by another method known to those of ordinary skill in the art.

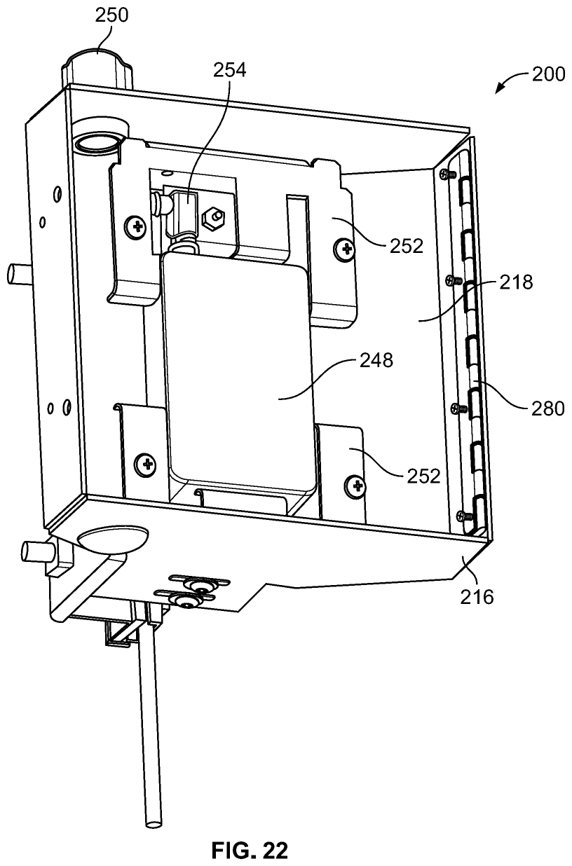

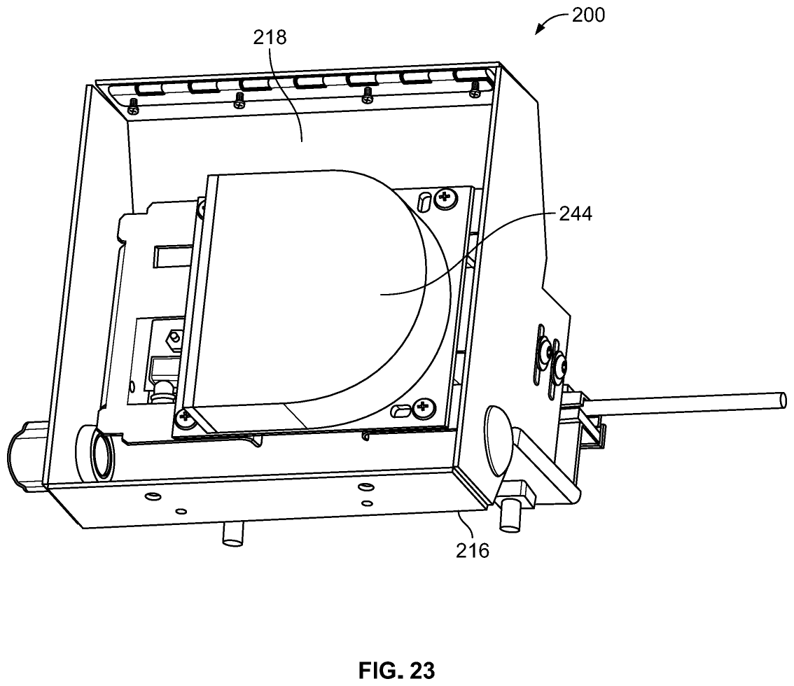

FIGS. 22 and 23 show the configuration of elements inside inner space 218. In the illustrated embodiment, in addition to the plurality of sensors 242, inner space 218 includes a sensor control unit 244, a routing unit such as a power over Ethernet (“POE”) unit (not shown) and a modem 248 (e.g., a cable modem). Those of ordinary skill in the art will recognize that other components may be included inside inner space 218 besides those shown. Control unit 244, routing unit 246 and modem 248 may be used as described above with respect to control unit 44, routing unit 46 and modem 48.

FIG. 22 illustrates how modem 248 may be attached to second housing portion 216 via one or more bracket 252. In the illustrated embodiment, modem 248 is attached to inside inner space 218 by being positioned against second housing portion 216 between two brackets 252 that are screwed to the inner surface of second housing portion 216. A right angle BNC adaptor 254 then enables modem 248 to be connected to an outside element, for example, via connector 250.

FIG. 23 illustrates how sensor control unit 244 may be placed next to modem 248, for example, by being screwed into the bracket 250 holding modem 248 in place. It should be understood that any one or more of sensor control unit 244, the POE unit and modem 248 may be attached to first housing portion 214, second housing portion 216 or any other surface inside inner space 218.

In the illustrated embodiment, all of the electrical components located within inner space 218 of housing 212 may be powered via a single communication line, for example, a 48 V DC communication line 74 such as an RG6 wire. In an embodiment, housing 112 includes a female F connector 154 which may be connected to a male F connector of the communication line 74, and the other end of the communication line 74 may be connected to a communication line tap 72 to provide monitoring device 200 with both power and data communication. Those of ordinary skill in the art will recognize that other connectors besides an F connector may be used for connector 250. Connector 250 may operate the same way as connector 50 described above.

Those of ordinary skill in the art will recognize that first housing portion 214 and second housing portion 216 may be removeably attached to each other in a variety of ways, for example, using detachable clamps or other attachment mechanisms. In the illustrated embodiment, first housing portion 214 and second housing portion 216 are rotatably attached via a hinge 280. Since inner space 218 of housing 212 includes electrical components, second housing portion 216 should be sealed to first housing portion 214 in a way that prevents water from entering inner space 218. In an embodiment, the outer edges of second housing portion 216 and/or first housing portion 214 may include a weather strip, for example, a foam strip that lines the edges. When second housing portion 216 is attached to first housing portion 214, the edges press against the weather strip 60 and provide a watertight seal. Those of ordinary skill in the art will recognize other ways to seal inner space 218 from water.

Monitoring device 200 may be attached to an overhead strand 70 in the same way as monitoring device 10 as illustrated in FIG. 12, and may be connected to a communication line tap 72 by a 48 V DC communication line 74 at connection 250 similar to how connection 50 operates above.

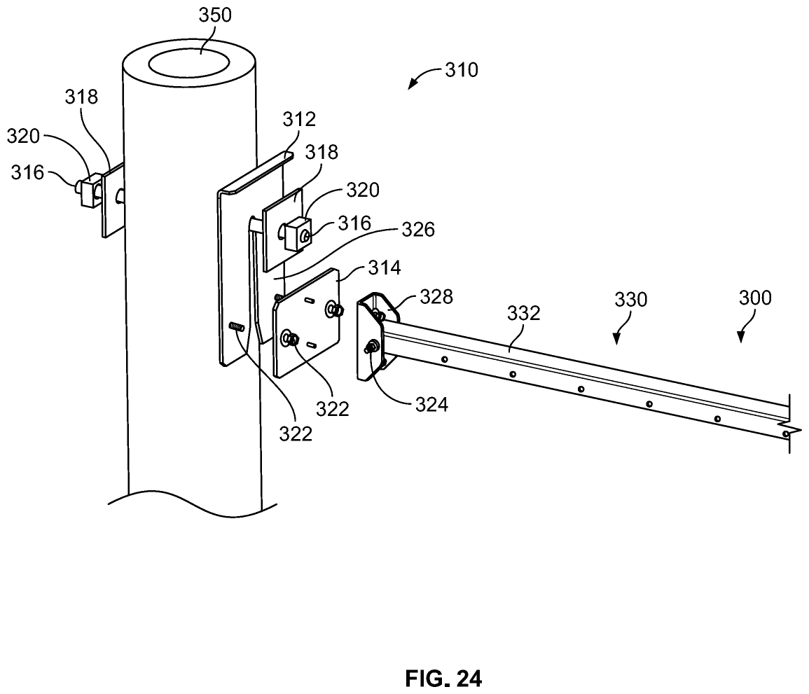

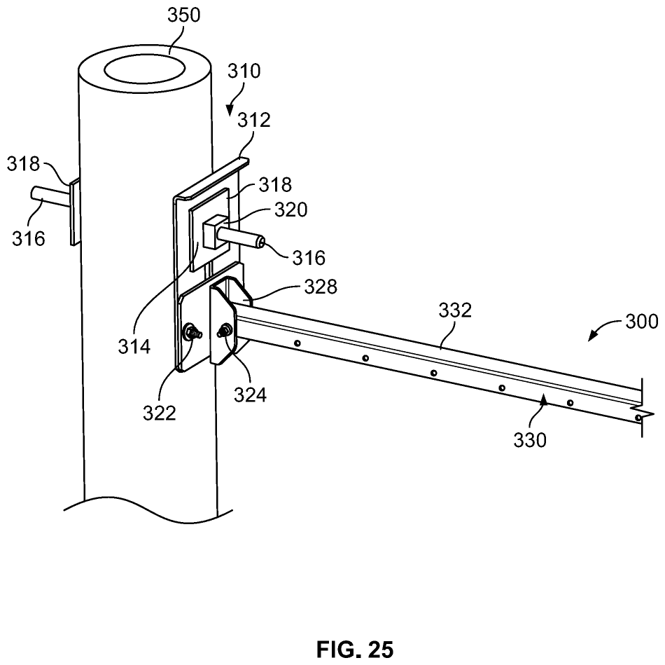

FIGS. 24 to 27 illustrate a stabilizing device 300 that may be used to stabilize a monitoring device 10, 100, 200 on an overhead strand. In the illustrated embodiment, stabilizing device 300 includes a pole attachment member 310 which may, for example, attach to a utility pole 350, and an extension member 330 which may, for example, extend towards and attach to a monitoring device 10, 100, 200.

In the illustrated embodiment, a pole attachment member 310 a first plate 312, a second plate 314, a rod 316, two washers 318 and two bolts 320. First plate 312 attaches directly to the utility pole 350 by placing rod 316 through the utility pole and fastening first plate 312 to utility pole 350 by tightening the bolts 320 to opposite ends of rod 316, sandwiching the two washers 318 therebetween. First plate 312 includes an elongated slot 326 which opens at an outer edge, which enables first plate 312 to be attached to and removed from utility pole 350 with the washers 318 and bolts 320 attached to rod 316. Second plate 314 then attaches to first plate 312 by tightening first screws or bolts 322, and extension member 330 attaches to second plate 314 via a first coupling 328 by tightening second screws or bolts 324. Those of ordinary skill in the art will recognize other ways of attaching the elements of pole attachment member 310 to each other, the utility pole 350, and extension member 330.

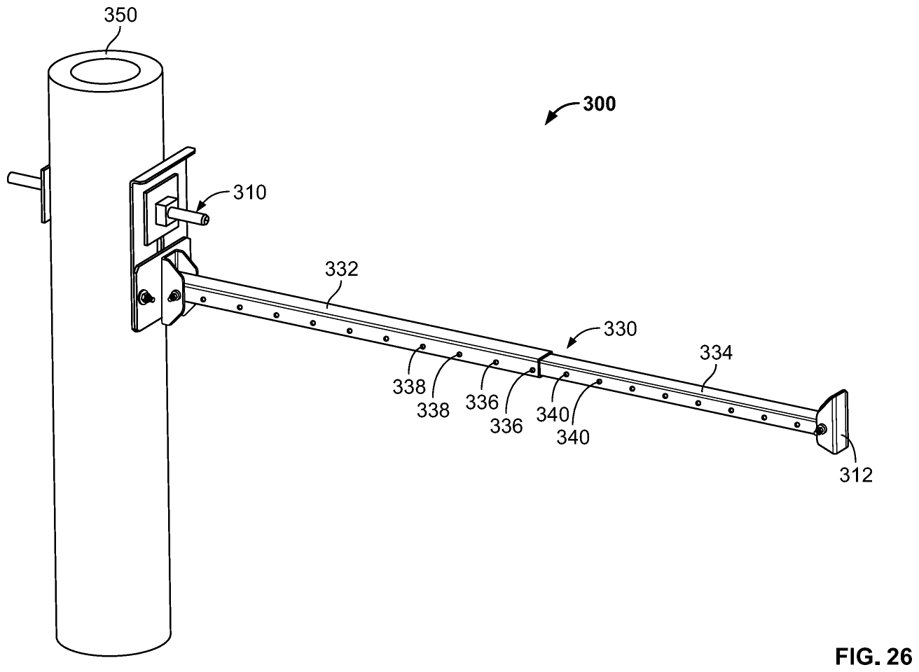

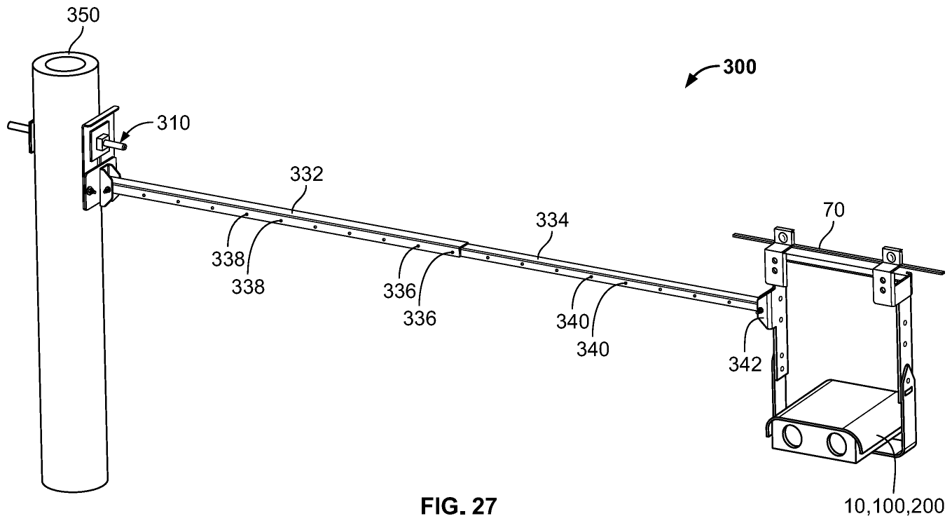

Extension member 330 includes a first portion 332 which attaches to second plate 314 via first coupling 328 by tightening second screws or bolts 324, and a second portion 334 that enables the length of extension member 330 to be adjusted to appropriately reach the location of a monitoring device, as illustrated, for example, by FIG. 27. As illustrated in FIGS. 26 and 27, the perimeter of first portion 332 is slightly larger than the perimeter of second portion 334, allowing second portion 334 to slide within first portion 332 to change the overall length of extension member 330. Once the appropriate length is adjusted, first portion 332 may be secured to second portion 334 by attaching screws 336 through first apertures 338 in first portion 332 and second apertures 340 in second portion 334.

As illustrated in FIG. 27, once extension member 330 has been adjusted to the appropriate length, extension member 330 may be attached to a monitoring device 10, 100, 200 via second coupling 342. The attachment via coupling 342 may be a direct attachment to housing 12, 112, 212, or may be an indirect attachment to one or more elements extending from housing 12, 112, 212, for example, to an attachment device 20, 120, 220. In the illustrated embodiment, the attachment of stabilizing device 300 to monitoring device 10, 100, 200 occurs in addition to the attachment of monitoring device 10, 100, 200 to an overhead strand 70. In alternative embodiment, monitoring device 10, 100, 200 may attach to one of stabilizing device 300 or overhead strand 70.

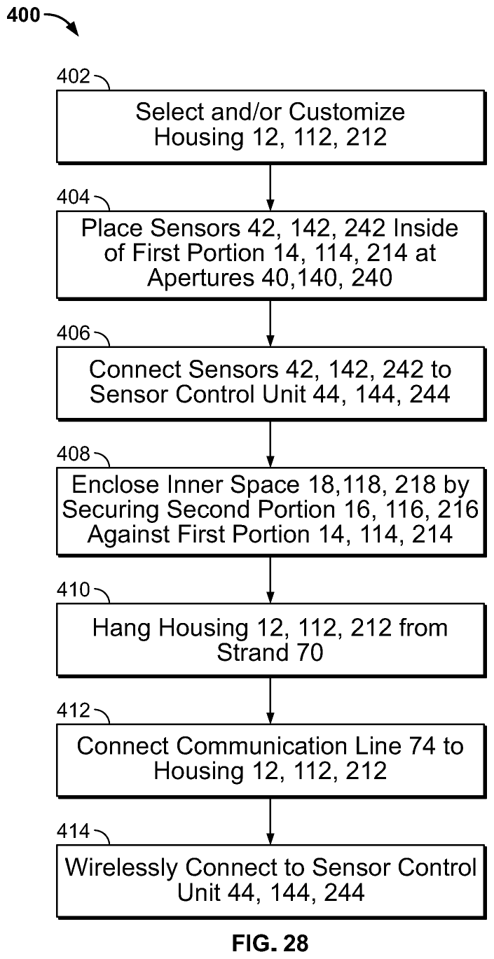

FIG. 28 shows a method 400 for preparing and installing monitoring device 10, 100, 200 on an overhead strand 70. Those of ordinary skill in the art will recognize that several of the steps of method 400 may be performed in different orders and/or omitted from method 400, and/or that additional steps may be added to method 400.

At step 402, a housing 12, 112, 212 is selected along with the user's choice of the type of sensors 42, 142, 242 to be inserted into housing 12, 112, 212. At this stage, the user may customize housing 12, 112, 212 using different types of sensors 42, 142, 242 and one or more of sensor control unit 44, 144, 244, POE unit 46, 146, 246 and modem 48, 148, 248. The user may also select a housing 12, 112, 212 with one or more sensors 42, 142, 242, sensor control unit 44, 144, 244, POE unit 46, 146, 246 and/or modem 48, 148, 248 already installed. In another embodiment, one or more of the sensor control unit 44, 144, 244, POE unit 46, 146, 246 and modem 48, 148, 248 is preinstalled on second housing portion 16, 116, 216, and the user may select the desired sensors 42, 142, 242 to be installed into first housing portion 14, 114, 214.

At step 404, the user may place the selected sensors 42, 142, 242 inside first housing portion 14, 114, 214, for example, by sliding each sensor 42, 142, 242 into a corresponding aperture 40, 140, 240 from inner space 18, 118, 218 while second housing portion 16, 116, 216 is removed from first housing portion 14, 114, 214. For example, each sensor 42, 142, 242 may slide into an aperture 40, 140, 240 until the wider diameter of the sensor casing prevents the sensor 42, 142, 242 from sliding any farther. Those of ordinary skill in the art will recognize other ways of attaching each sensor 42, 142, 242 to an aperture 40, 140, 240. If a sensor 42, 142, 242 is not used with an aperture 40, 140, 240, the user may choose to block the aperture 40, 140, 240 so that water may not pass through the empty aperture 40, 140, 240 into inner space 18, 118, 218 of housing 12, 112, 212. The sensors may be secured, for example, by being screwed into apertures 40, 140, 240, and any unused apertures 40 may be sealed with solid rubber gaskets.

At step 406, the user may wire each of the sensors 42, 142, 242 to sensor control unit 44, 144, 244. The user may also attach any other wires 54 necessary if the wires 54 are not preinstalled. The wiring may also be performed prior to placing the sensors 42, 142, 242 in the apertures 40, 140, 240.

At step 408, second housing portion 16, 116, 216 may be secured to first housing portion 14, 114, 214, such that the seal between first housing portion 14, 114, 214, and second housing portion 16, 116, 216 is watertight. The securement may be made, for example, by clamps or another attachment mechanism. For example, second housing portion 16, 116, 216 and/or first housing portion may include a weather strip 60 to provide a tight seal between first housing portion 14, 114, 214 and second housing portion 16, 116, 216 and/or may be configured to create an overhang.

At step 410, the user has selected a location to hang monitoring device 10 from an overhead strand 70. The location should preferably be proximal to a communication line tap 72. In the illustrated embodiment, monitoring device 10, 100, 200 may be hung from a strand 70 using attachment device 20, 120, 220 by hooking one or more contact portion of attachment device 20, 120, 220 over the strand 70. Monitoring device 10, 100, 200 may also be attached to a utility pole via a stabilizing device 300 at this time.

At step 412, the user may connect one end of a 48 V DC communication line 74 to a connector 50, 150, 250 or another connector of monitoring device 10 and the other end of communication line 74 to an F connector or other connector on communication line tap 72. Once connected to communication line tap 72, monitoring device 10, 100, 200 may be automatically powered or may require the user to turn on power with an on/off switch.

At step 414, the user may connect wirelessly with monitoring device via modem 48, 148, 248 and control sensors 42, 142, 242 and/or obtain information from sensors 42, 142, 242. If the sensors 42, 142, 242 are cameras, for example, the user may view images and/or video from the cameras and possibly move the field of view of the cameras. If the sensors 42, 142, 242 collect data but not images or video, the user may retrieve the data at a remote location.

It should be understood that various changes and modifications to the presently preferred embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. A monitoring device, comprising:
a first housing portion including a bottom surface and a plurality of side surfaces positioned to form an open top side, wherein at least one of the plurality of side surfaces is angled outwardly from the bottom surface towards the open top side, and wherein at least one of the bottom surface and the plurality of side surfaces includes at least one aperture configured to receive a sensor;
a second housing portion configured to attach to the first housing portion so as to cover the open top side of the first housing portion, thereby providing an inner space between the first and second housing portions;
an attachment device enabling the attached first and second housing portions to hang from an overhead strand; and
a connector configured to receive power from a communication line tap to power at least one component within the inner space while the attachment device hangs the first and second housing portions from the overhead strand.

2. The monitoring device of claim 1, wherein two opposing surfaces of the plurality of side surfaces include at least two apertures each configured to receive a corresponding sensor.

3. The monitoring device of claim 1, wherein each aperture is positioned such that a corresponding sensor can protrude from the inner space therethrough.

4. The monitoring device of claim 1, wherein the second housing portion includes a curved upper surface.

5. The monitoring device of claim 1, wherein at least one of the plurality of side surfaces has a trapezoid shape.

6. The monitoring device of claim 1, wherein the first housing portion includes four side surfaces, and wherein all four side surfaces have trapezoid shapes.

7. The monitoring device of claim 1, wherein the plurality of side surfaces includes a first set of opposed side surfaces and a second set of opposed side surfaces, and wherein the first set of opposed side surfaces is at least twice as long as the second set of opposed side surfaces when measured from a bottom edge.

8. The monitoring device of claim 1, wherein the plurality of side surfaces includes a first set of opposed side surfaces and a second set of opposed side surfaces, and wherein the first set of opposed side surfaces is at least three times as long as the second set of opposed side surfaces when measured from a bottom edge.

9. The monitoring device of claim 1, wherein a top edge of at least one of the side surfaces is at least twice as long as a height of the at least one of the side surfaces.

10. The monitoring device of claim 1, wherein the second housing portion is removably attachable to the first housing portion.

11. The monitoring device of claim 1, wherein each aperture is configured to interchangeably receive a plurality of different types of sensors.

12. The monitoring device of claim 1, wherein the at least one component within the inner space includes at least one of a sensor control unit, a routing unit, and a modem.

13. The monitoring device of claim 12, wherein the sensor control unit, the routing unit, or the modem is attached to a surface of the second housing portion.

14. The monitoring device of claim 1, wherein the attachment device is attached to the second housing portion.

15. The monitoring device of claim 1, wherein the bottom surface and at least one of the plurality of side surfaces each include at least one aperture configured to receive a sensor.

16. A monitoring device comprising:
a housing having an inner space enclosed by a bottom surface, at least one side surface, and a top surface, the at least one side surface angled outwardly from the bottom surface to the top surface;
at least one sensor positioned at an aperture in at least one of the bottom surface and the at least one side surface;
an attachment device enabling the housing to hang from an overhead strand; and
a connector configured to transfer power from a communication line tap to power the at least one sensor while the attachment device hangs the housing from the overhead strand.

17. The monitoring device of claim 16, which includes a plurality of sensors positioned at a plurality of apertures in at least one of the bottom surface and the at least one side surface, wherein the plurality of sensors are each connected to a sensor control unit located within the inner space.

18. The monitoring device of claim 16, wherein the connector is an F connector configured to couple to a communication line connected to the communication line tap.

19. The monitoring device of claim 16, wherein the housing includes a first housing portion and a second housing portion, the first housing portion providing the bottom surface and the at least one side surface, the second housing portion providing the top surface.

20. The monitoring device of claim 19, wherein the second housing portion is removably attachable to the first housing portion.

21. The monitoring device of claim 16, wherein the bottom surface is an edge where two side surfaces meet.

22. The monitoring device of claim 16, wherein the connector is configured to transfer power to a routing unit, and wherein the routing unit provides power to the at least one sensor.

23. The monitoring device of claim 22, wherein the routing unit provides power to a modem.

24. A method of installing a monitoring device comprising:
configuring a monitoring device with at least one sensor;
hanging the monitoring device from an overhead strand attached to a utility pole; and
connecting a communication line from a communication line tap to the monitoring device to power the at least one sensor.

25. The method of claim 24, further comprising wirelessly controlling the at least one sensor.

26. The method of claim 24, further comprising wirelessly retrieving data from the at least one sensor.

27. The method of claim 24, further comprising configuring the monitoring device with a plurality of different types of sensors.
